(19) United States
(12) Patent Application Publication
(10) Pub. No.: US 2015/0005999 A1
(43) Pub. Date: Jan. 1, 2015

(54) SYSTEM AND METHOD FOR CONTROLLING DRIVING MODE OF HYBRID VEHICLE

(71) Applicants: KIA MOTORS CORPORATION, Seoul (KR); HYUNDAI MOTOR COMPANY, Seoul (KR)

(72) Inventors: Yong Kak Choi, Seoul (KR); Il Kwon Park, Seoul (KR)

(73) Assignees: KIA MOTORS CORPORATION, Seoul (KR); HYUNDAI MOTOR COMPANY, Seoul (KR)

(21) Appl. No.: 14/070,863

(22) Filed: Nov. 4, 2013

(30) Foreign Application Priority Data
Jun. 28, 2013 (KR) 10-2013-0075166

(51) Int. Cl. F02D 29/02

(52) U.S. Cl. CPC F02D 29/02; Y10S 903/903
USPC 701/22; 180/65.28; 903/903

(57) ABSTRACT

A system and method for controlling a driving mode of a hybrid vehicle are provided. The method includes setting, by a controller, an engine-on control level based on an SOC (state of charge) of a battery and calculating a compensation factor based on a speed of the vehicle and a road gradient. The controller is configured to reflect the compensation factor in the engine-on control level and calculate a compensated engine-on control level. In addition, the method includes comparing, by the controller, a driver expectation power to the compensated engine-on control level and starting the engine when the driver expectation power is greater than the compensated engine-on control level.

### CROSS-REFERENCE TO RELATED APPLICATION

This application claims under 35 U.S.C. §119(a) priority to Korean Patent Application No. 10-2013-0075166 filed on Jun. 28, 2013, the entire contents of which are incorporated herein by reference.

### BACKGROUND

1. Field of the Invention

The present invention relates to a system and method for controlling a driving mode of a hybrid vehicle in which driving load conditions are classified into several sections based on an average speed of the vehicle and a road gradient, and engine operation transition control is conducted using the classified sections.

2. Description of the Related Art

In parallel type hybrid vehicles, an engine clutch is disposed between an engine and a drive motor. Thus, transmission of power may be controlled from the engine to the wheels. Particularly, in the parallel type hybrid vehicles, when a vehicle decelerates, the vehicle enters a regenerative braking mode to stop the engine and release an engine clutch to cause braking energy to be directly absorbed by the motor.

The tem SOC (state of charge) refers to the state of charge of a high-voltage battery, in other words, the amount of charge of the battery. The high-voltage battery functions as a damper to charge from a motor or discharge to the motor to operate the engine at the optimum efficiency. However, when the engine frequently alternates between start and stop, the fuel efficiency thereof is reduced, and the load applied to the entire system increases. Therefore, it is required to appropriately control the hybrid system, reflecting the intention of a driver, whereby the start and stop of the engine may be efficiently and reliably conducted.

The foregoing is intended merely to aid in the understanding of the background of the present invention, and is not intended to mean that the present invention falls within the purview of the related art that is already known to those skilled in the art.

### SUMMARY

Accordingly, the present invention provides a method for controlling a driving mode of a hybrid vehicle in which driving load conditions are classified into several sections based on an average speed of the vehicle and a road gradient, and engine operation transition control is conducted using the classified sections.

In an aspect of the present invention a method for controlling a driving mode of a hybrid vehicle may include: setting an engine-on control level based on an SOC (state of charge) of a battery; calculating a compensation factor based on both a speed of the vehicle and a road gradient; reflecting the compensation factor in the engine-on control level and calculating a compensated engine-on control level; and comparing a driver expectation power to the compensated engine-on control level and starting the engine when the driver expectation power exceeds the compensated engine-on control level.

The level setting operation may include determining a mode based on the SOC of the battery, and setting the engine-on control level based on the speed of the vehicle in the determined mode. The compensation calculation operation may include applying the speed of the vehicle and the road gradient to a data map and calculating a compensation factor, the data map may receive the vehicle speed and the road gradient as an input and output the compensation factor. The compensation calculation operation may include a plurality of vehicle speed modes classified based on an average vehicle speed per unit time and the number of stops the vehicle has made. In the compensation calculation operation, as the road gradient increases, the compensation factor may be increased, thus causing the engine-on control level to increase.

In another aspect of the present invention a method for controlling a driving mode of a hybrid vehicle may include: setting a first engine-on control level and a second engine-on control level based on an SOC of a battery; calculating a compensation factor based on both a speed of the vehicle and a road gradient; reflecting the compensation factor in the first engine-on control level and the second engine-on control level and calculating a compensated first engine-on control level and a compensated second engine-on control level; and starting an engine when an integrated value of the driver expectation power during a time period when the driver expectation power exceeds the compensated second engine-on control level or the compensated first engine-on control level is greater than a predetermined value.

In a further aspect, the present invention provides a method for controlling a driving mode of a hybrid vehicle that may include: setting a first engine-on control level and a second engine-on control level based on an SOC of a battery; calculating a compensation factor based on both a speed of the vehicle and a road gradient; reflecting the compensation factor in the first engine-on control level and calculating a compensated first engine-on control level; and starting an engine when an integrated value of the driver expectation power during a time period when the driver expectation power exceeds the compensated second engine-on control level or the compensated first engine-on control level is greater than a predetermined value. The second engine-on control level may be greater than the first engine-on control level.

In yet another aspect of the present invention a method for controlling a driving mode of a hybrid vehicle may include: setting an engine-off control level based on an SOC of the battery; calculating a compensation factor based on both a vehicle speed and a road gradient; reflecting the compensation factor in the engine-off control level and calculating a compensated engine-off control level; and comparing a driver expectation power to the compensated engine-off control level and stopping an engine when the driver expectation power is less than the compensated engine-off control level.

In still another aspect, the present invention provides a method for controlling a driving mode of a hybrid vehicle that may include: setting an engine-on control level or an engine-off control level based on a speed of the vehicle and an SOC of the battery; reflecting a compensation factor in the engine-on control level or the engine-off control level based on both the speed of the vehicle and a road gradient and calculating a compensated engine-on control level or a compensated engine-off control level; and comparing a driver expectation power to the engine-on control level or the engine-off control level and operating starting and stopping of an engine.

Accordingly, the method for controlling a driving mode of a hybrid vehicle according to an exemplary embodiment of the present invention may prevent an engine from excessively alternating between starting and stopping, thereby enhancing the fuel efficiency. Furthermore, the present invention may prevent an excessive load from being applied to the engine and the clutch. In addition, the amount of charge of the battery may be effectively ensured.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary view showing engine start operation of a method for controlling a driving mode of a hybrid vehicle, according to an exemplary embodiment of the present invention;

FIG. 2 is an exemplary flowchart showing a method of calculating a compensation factor in the driving mode control method according to the exemplary embodiment of the present invention;

FIG. 3 is an exemplary table showing the method of calculating the compensation factor in the driving mode control method according to the exemplary embodiment of the present invention;

FIG. 4 is an exemplary view showing engine stop operation of the driving mode control method according to the exemplary embodiment of the present invention; and

FIG. 5 is an exemplary graph showing the effects of the driving mode control method according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, a method for controlling a driving mode of a hybrid vehicle according to exemplary embodiments of the present invention will be described in detail with reference to the attached drawings.

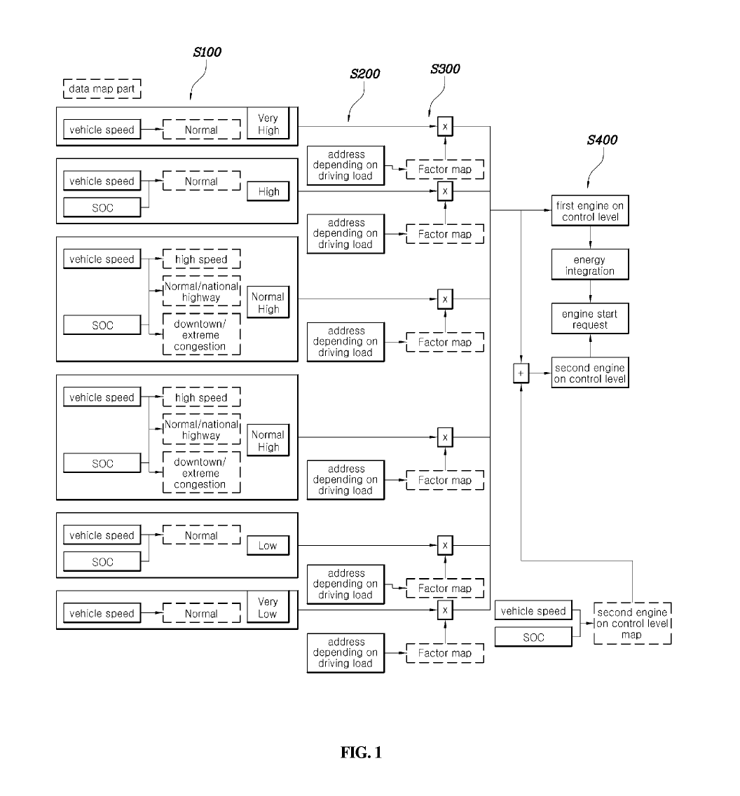

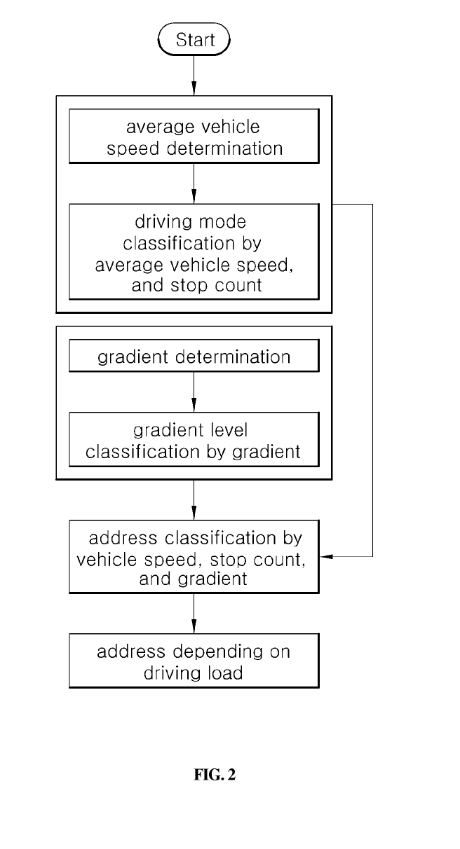

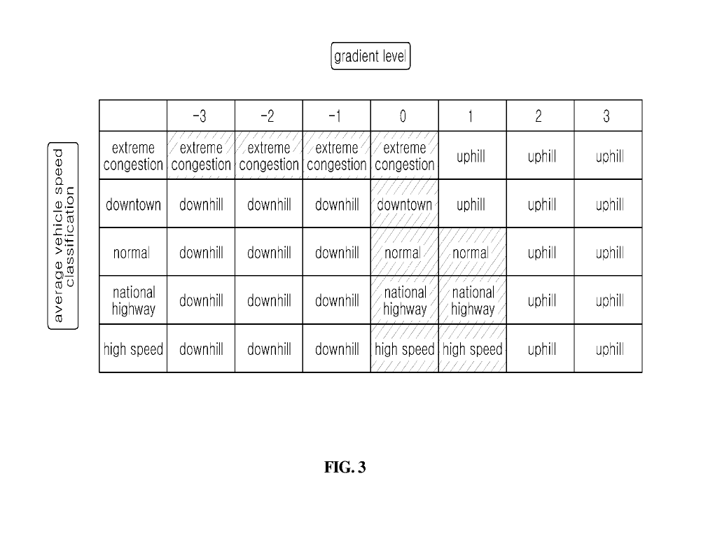

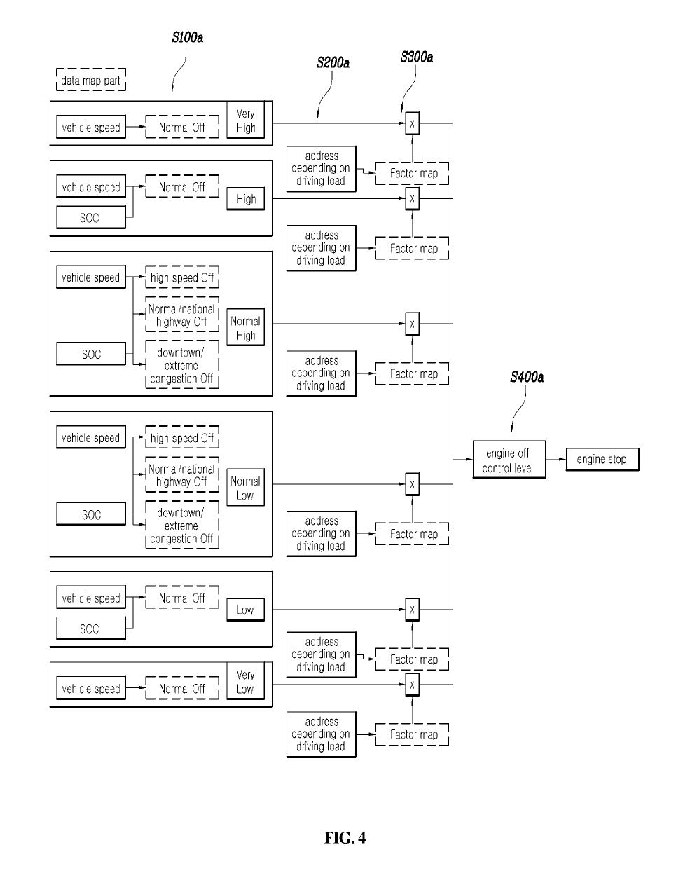

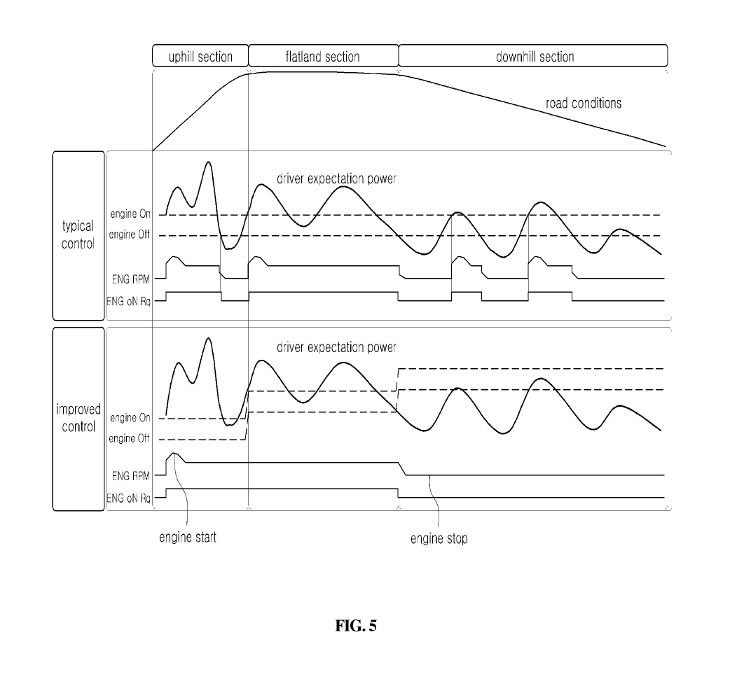

FIG. 1 is an exemplary view showing engine start operation of the driving mode control method according to the exemplary embodiment of the present invention. FIG. 2 is an exemplary flowchart showing a method of calculating a compensation factor in the driving mode control method according to the exemplary embodiment of the present invention. FIG. 3 is an exemplary table showing a method of calculating a compensation factor in the driving mode control method according to the exemplary embodiment of the present invention. FIG. 4 is an exemplary view showing engine stop operation of the driving mode control method according to the exemplary embodiment of the present invention. FIG. 5 is an exemplary graph showing the effects of the driving mode control method according to the exemplary embodiment of the present invention.

FIG. 1 illustrates the engine start operation of the driving mode control method according to the exemplary embodiment of the present invention. The driving mode control method according to an exemplary embodiment of the present invention may include: a level setting operation S100 of setting, by a controller, an engine-on control level based on a SOC of a battery; a compensation calculation operation S200 of calculating, by the controller, a compensation factor based on both a vehicle speed and a road gradient; a compensation reflection operation S300 of reflecting, by the controller, the compensation factor in the engine-on control level and calculating a compensated engine-on control level; and an engine control operation S400 of comparing, by the controller, driver expectation power to the compensated engine-on control level and starting the engine when the driver expectation power exceeds the compensated engine-on control level.

First, the level setting operation S100 of setting the engine-on control level based on the SOC of the battery may be performed. In the level setting operation S100, a mode may be determined based on the SOC of the battery. In the determined mode, the engine-on control level may be set based on a vehicle speed. In other words, a plurality (e.g., six) types of modes from VERY HIGH to VERY LOW are previously determined based on the SOC. After the mode is determined by determining the amount of charge, the vehicle speed may be applied to a data map provided in each mode, thus setting the engine-on control level. Thereafter, in the compensation calculation operation S200, a compensation factor may be calculated, by the controller, based on both a vehicle speed and a road gradient.

Subsequently, in the compensation reflection operation S300, the compensation factor may be reflected in the engine-on control level, thus a compensated engine-on control level may be calculated by the controller. In the engine control operation S400, a driver expectation power may be compared, by the controller, to the compensated engine-on control level, and the engine may be started when the driver expectation power exceeds the compensated engine-on control level. In other words, the engine-on control level may be set based on a current SOC of the battery, and the engine-on control level may be set more precisely using the speed of the vehicle. Thereafter, the compensation factor, which is reflected in the driving conditions, i.e. the vehicle speed and the road gradient, may be calculated. The compensation factor may be reflected in the engine-on control level, wherein an engine-on control level in which the SOC of the battery, conditions of the vehicle and conditions of a driving road that have been reflected may be obtained. The driver expectation power may be obtained by an APS (Accelerator Pedal Sensor) or the like and may then be compared to the engine-on control level. When the driver expectation power exceeds the engine-on control level, the engine may start.

FIG. 2 illustrates an exemplary method of calculating the compensation factor in the driving mode control method according to the exemplary embodiment of the present invention. In the compensation calculation operation, a speed of the vehicle and a road gradient may be input to the data map which receives a vehicle speed and a road gradient as the input and outputs, by the controller, a compensation factor. In this way, the compensation factor may be obtained. In particular, the present invention may have a plurality of vehicle speed modes. An average vehicle speed per unit time may be calculated, and is the average vehicle speed per unit time may be combined with a road gradient level which corresponds to one of the vehicle speed modes, thus obtaining a compensation factor.

FIG. 3 is an exemplary table showing the method of calculating the compensation factor in the driving mode control method according to the exemplary embodiment of the present invention. In the compensation calculation operation, with regard to the vehicle speed, there are a plurality of modes. The vehicle speed modes may be classified based on the average vehicle speed per unit time and the number of stops the vehicle has made. With regard to the road gradient, there may be a plurality of modes from about −3 to +3 which correspond to an uphill road, a flat road and a downhill road. The vehicle speed modes may be classified into five stages from an extreme congestion mode to a high speed mode. Each mode may contain an appropriate compensation factor therein. As necessary, a compensation factor may be determined after the road gradient and the vehicle speed are prioritized.

The compensation calculation operation may be configured such that, as the road gradient increases, the compensation factor may increase and the engine-on control level may also increase. Furthermore, in the extreme congestion mode or a downtown mode, when the modes are classified based on the number of stops of the vehicle per unit time, the compensation factor may be effectively calculated.

Meanwhile, a method for controlling a driving mode of a hybrid vehicle according to another exemplary embodiment of the present invention may include: a level setting operation S100 of setting, by a controller, a first engine-on control level and a second engine-on control level based on the SOC of the battery; a compensation calculation operation S200 of calculating, by the controller, a compensation factor based on both a vehicle speed and a gradient; a compensation reflection operation S300 of reflecting, by the controller, the compensation factor in the first engine-on control level and the second engine-on control level and calculating a compensated first engine-on control level and a compensated second engine-on control level; and an engine control operation S400 of starting, by the controller, the engine when an integrated value of the driver expectation power during the time period when the driver expectation power exceeds the compensated second engine-on control level or the compensated first engine-on control level is greater than a predetermined value.

Furthermore, the above exemplary embodiment is when the engine-on control level includes the first engine-on control level and the second engine-on control level. In this case, the second engine-on control level may be greater than the first engine-on control level. In particular, when the compensation factor is calculated, the compensation factor may be reflected in both the first engine-on control level and the second engine-on control level. When the driver expectation power exceeds the compensated second engine-on control level, the engine may be started by the controller.

Furthermore, when an integrated value of the driver expectation power during the time period when the driver expectation power exceeds the compensated first engine-on control level is greater than a predetermined value, the engine may be started. Further, in this operation may the driver expectation power may be suddenly increased or may be gradually increased. The engine may rapidly be started to meet the intention of the driver when the driver expectation power is suddenly increased.

Moreover, the method, in which the engine starts when an integrated value of the driver expectation power during the time period when the driver expectation power exceeds the compensated first engine-on control level is greater than a predetermined value, may also be applied to the case when the first engine-on control level is used without having the second engine-on control level.

A method for controlling a driving mode of a hybrid vehicle according to a further exemplary embodiment of the present invention may include: a level setting operation S100 of setting, by a controller, a first engine-on control level and a second engine-on control level based on the SOC of the battery; a compensation calculation operation S200 of calculating, by the controller, a compensation factor based on both a vehicle speed and a road gradient; a compensation reflection operation S300 of reflecting, by the controller, the compensation factor in the first engine-on control level and calculating a compensated first engine-on control level; and an engine control operation S400 of starting, by the controller, the engine when an integrated value of the driver expectation power during the time period when the driver expectation power exceeds the compensated second engine-on control level or the compensated first engine-on control level is greater than a predetermined value. In other words, the compensation factor may be reflected in the first engine-on control level wherein the first engine-on control level may vary depending on surrounding conditions.

FIG. 4 illustrates an exemplary engine stop operation of the driving mode control method according to the exemplary embodiment of the present invention. The driving mode control method according to the exemplary embodiment of the present invention may include: an off level setting operation S100a of setting, by the controller, an engine-off control level based on the SOC of the battery; an off compensation calculation operation S200a of calculating, by the controller, a compensation factor based on both a vehicle speed and a road gradient; an off compensation reflection operation S300a of reflecting, by the controller, the compensation factor in the engine-off control level and calculating a compensated engine-off control level; and an engine control operation S400a of comparing, by the controller, driver expectation power to the compensated engine-off control level and stopping the engine when the driver expectation power is less than the compensated engine-off control level. In the same manner as the starting of the engine, for stopping of the engine, the engine-off control level may be set to be compensated by the compensation factor. Thereby, the engine may be prevented from being excessively stopped.

FIG. 5 is an exemplary graph showing the effects of the driving mode control method according to the exemplary embodiment of the present invention. As in the conventional technique, when the engine-on control level or the engine-off control level are constant, the driver expectation power frequently passes in and out of the engine-on control level and the engine-off control level, thus excessively alternating starting and stopping of the engine. This affects the fuel efficiency and performance of the vehicle.

In the present invention, the engine-on control level or the engine-off control level may be set based on the speed of the vehicle and the SOC of the battery. A compensation factor that is determined based on both a speed of the vehicle and a road gradient may be reflected in the engine-on control level or the engine-off control level, thus calculating a compensated engine-on control level or a compensated engine-off control level. While comparing the driver expectation power to the compensated engine-on control level or engine-off control level, the starting or stopping of the engine may be controlled. Therefore, the time period for which the operation of the engine may be maintained after the engine has started may be greater than that of the conventional technique. Nevertheless, the SOC of the battery may be more stably maintained, compared to that of the conventional technique. Rather, a start load of the engine may be reduced, thus enhancing the fuel efficiency.

As described above, a method for controlling a driving mode of a hybrid vehicle according to the present invention may prevent an engine from excessively alternating between starting and stopping, thereby enhancing the fuel efficiency. Furthermore, the present invention may prevent an excessive load from being applied to the engine and the clutch. In addition, the amount of charge of the battery may be effectively ensured.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for controlling a driving mode of a vehicle, comprising:
setting, by a controller, an engine-on control level based on an SOC (state of charge) of a battery;
calculating, by the controller, a compensation factor based on a speed of the vehicle and a road gradient;
reflecting, by the controller, the compensation factor in the engine-on control level and calculating a compensated engine-on control level; and
comparing, by the controller, a driver expectation power to the compensated engine-on control level and starting the engine when the driver expectation power is greater than the compensated engine-on control level.

2. The method as set forth in claim 1, wherein setting the engine-on level includes:
determining, by the controller, a mode based on the SOC of the battery; and
setting, by the controller, the engine-on control level based on the speed of the vehicle in the determined mode.

3. The method as set forth in claim 1, wherein calculating the compensation factor includes:
applying, by the controller, the speed of the vehicle and the road gradient to a data map; and
calculating, by the controller, a compensation factor, wherein the data map receives the vehicle speed and the road gradient as an input and outputs, by the controller, the compensation factor.

4. The method as set forth in claim 1, wherein the compensation calculation process includes a plurality of vehicle speed modes classified based on an average vehicle speed per unit time and the number of stops the vehicle has made.

5. The method as set forth in claim 1, wherein in calculating the compensation factor, as the road gradient increases, the compensation factor is increased, causing the engine-on control level to increase.

6. A method for controlling a driving mode of a vehicle, comprising:
setting, by the controller, a first engine-on control level and a second engine-on control level based on an SOC (state of charge) of a battery;
calculating, by the controller, a compensation factor based on a speed of the vehicle and a road gradient;
reflecting, by the controller, the compensation factor in the first engine-on control level and the second engine-on control level and calculating a compensated first engine-on control level and a compensated second engine-on control level; and
starting, by the controller, an engine when an integrated value of the driver expectation power during a period time when the driver expectation power is greater than the compensated second engine-on control level or the compensated first engine-on control level is greater than a predetermined value.

7. A method for controlling a driving mode of a vehicle, comprising:
setting, by the controller, a first engine-on control level and a second engine-on control level based on an SOC (state of charge) of a battery;
calculating, by the controller, a compensation factor based on a speed of the vehicle and a road gradient;
reflecting, by the controller, the compensation factor in the first engine-on control level and calculating a compensated first engine-on control level; and
starting, by the controller, an engine when an integrated value of the driver expectation power during a time period when the driver expectation power is greater than the compensated second engine-on control level or the compensated first engine-on control level is greater than a predetermined value.

8. The method as set forth in claim 7, wherein the second engine-on control level is greater than the first engine-on control level.

9. A method for controlling a driving mode of a vehicle, comprising:
setting, by the controller, an engine-off control level based on an SOC (state of charge) of the battery;
calculating, by the controller, a compensation factor based on a vehicle speed and a road gradient;
reflecting, by the controller, the compensation factor in the engine-off control level and calculating a compensated engine-off control level; and
comparing, by the controller, a driver expectation power to the compensated engine-off control level and stopping an engine when the driver expectation power is less than the compensated engine-off control level.

10. A method for controlling a driving mode of a vehicle, comprising:
setting, by the controller, an engine-on control level or an engine-off control level based on a speed of the vehicle and an SOC (state of charge) of the battery;
reflecting, by the controller, a compensation factor in the engine-on control level or the engine-off control level based on the speed of the vehicle and a road gradient and calculating a compensated engine-on control level or a compensated engine-off control level; and
comparing, by the controller, a driver expectation power to the engine-on control level or the engine-off control level and controlling starting and stopping of an engine.

11. A system for controlling a driving mode of a vehicle, comprising:
a controller includes a memory and a processor, the memory configured to store program instructions and the processor configured to execute the program instructions, the program instructions when executed configured to:
set an engine-on control level based on an SOC (state of charge) of a battery;
calculate a compensation factor based on a speed of the vehicle and a road gradient;
reflect the compensation factor in the engine-on control level and calculating a compensated engine-on control level; and
compare a driver expectation power to the compensated engine-on control level and start the engine when the driver expectation power is greater than the compensated engine-on control level.

12. The system of claim 11, wherein the program instructions when executed are further configured to:
determine a mode based on the SOC of the battery; and
set the engine-on control level based on the speed of the vehicle in the determined mode.

13. The system of claim 11, wherein the program instructions when executed are further configured to:apply the speed of the vehicle and the road gradient to a data map; and
calculate a compensation factor, wherein the data map receives the vehicle speed and the road gradient as an input and outputs, by the controller, the compensation factor.

14. The system of claim 11, wherein the compensation calculation process includes a plurality of vehicle speed modes classified based on an average vehicle speed per unit time and the number of stops the vehicle has made.

15. The system of claim 11, wherein in calculating the compensation factor, as the road gradient increases, the compensation factor is increased, causing the engine-on control level to increase.

16. A non-transitory computer readable medium containing program instructions executed by a controller, the computer readable medium comprising:
program instructions that set an engine-on control level based on an SOC (state of charge) of a battery;
program instructions that calculate a compensation factor based on a speed of the vehicle and a road gradient;
program instructions that reflect the compensation factor in the engine-on control level and calculating a compensated engine-on control level; and
program instructions that compare a driver expectation power to the compensated engine-on control level and start the engine when the driver expectation power is greater than the compensated engine-on control level.

17. The non-transitory computer readable medium of claim 16, further comprising:
program instructions that determine a mode based on the SOC of the battery; and
program instructions that set the engine-on control level based on the speed of the vehicle in the determined mode.

18. The non-transitory computer readable medium of claim 16, further comprising:
apply the speed of the vehicle and the road gradient to a data map; and
calculate a compensation factor, wherein the data map receives the vehicle speed and the road gradient as an input and outputs, by the controller, the compensation factor.

19. The non-transitory computer readable medium of claim 16, wherein the compensation calculation process includes a plurality of vehicle speed modes classified based on an average vehicle speed per unit time and the number of stops the vehicle has made.

20. The non-transitory computer readable medium of claim 16, wherein in calculating the compensation factor, as the road gradient increases, the compensation factor is increased, causing the engine-on control level to increase.
